(19) United States
(12) Patent Application Publication
(10) Pub. No.: US 2006/0178149 A1
(43) Pub. Date: Aug. 10, 2006

(54) Systems and methods for wireless cellular telephone routers

(76) Inventors: Sandip D. Kamat, San Marcos, CA (US); Vineet Shrivastava, San Marcos, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/051,897

(22) Filed: Feb. 4, 2005

(51) Int. Cl. H04Q 7/20

(52) U.S. Cl. 455/445; 455/434

(57) ABSTRACT

In some embodiments, systems and methods for wireless telephone routers include cellular telephones that function as routers and/or as gateways between two networks. According to some embodiments, wireless telephone routers may provide ad-hoc network and/or Internet access to a plurality of network devices.

### TECHNICAL FIELD

The present disclosure relates generally to systems and methods for wireless cellular telephone routers.

### BACKGROUND

Wireless routers are often employed to offer network connectivity to various network devices. A consumer may, for example, purchase and utilize a wireless router to establish a wireless Local Area Network (LAN) within the consumer's home. Network devices within the consumer's home may then interface with the router via the LAN. Typically, the router may also be connected to another network such as the Internet (e.g., via a modem connected to an Internet Service Provider (ISP)). The router may, for example, provide access to the Internet to any network devices connected to the LAN.

The same consumer may typically also carry and/or have access to a cellular telephone. Many cellular telephones allow the consumer to access the Internet via an internal modem. This internal modem is not, however, typically accessible to other network devices. When the user operates the cellular telephone within the consumer's home, for example, the network devices within the consumer's home must still rely on the wireless router to achieve Internet connectivity.

Accordingly, there is a need for systems and methods for wireless cellular telephone routers that address these and other problems found in existing technologies.

### SUMMARY

Systems and methods are therefore presented for providing wireless cellular telephone routers.

According to some embodiments, systems and methods may comprise a first wireless transceiver to communicate via a first wireless network, a memory configured to store instructions, a processor coupled to the memory and the first transceiver, the processor being configured to execute the stored instructions to provide a plurality of network devices coupled with access to the first wireless network. In some embodiments, the processor may be further configured to provide the plurality of network devices with access to a second network. Embodiments may further comprise a second wireless transceiver to communicate via the second network.

According to some embodiments, systems and methods are operable to activate, by a cellular telephone, a first wireless transmitter, broadcast, via the first wireless transmitter, an identification signal associated with a first wireless network, receive, via a first wireless receiver, a first identification signal associated with a first network device, authenticate, by the cellular telephone, the first identification signal, and provide the first network device with access to the first wireless network. In some embodiments, the first network device may also be provided with access to a second network. Embodiments may further be operable to receive, via the first wireless receiver, a second identification signal associated with a second network device, authenticate, by the cellular telephone, the second identification signal, and provide the second network device with access to the first wireless network. In some embodiments, the second network device may also be provided with access to the second network.

With these and other advantages and features of embodiments that will become hereinafter apparent, embodiments may be more clearly understood by reference to the following detailed description, the appended claims and the drawings attached herein.

### BRIEF DESCRIPTION OF THE DRAWINGS

FIG. 1 is a block diagram of a communication system;

FIG. 2 is a block diagram of a communication system according to some embodiments;

FIG. 3 is a flowchart of a method according to some embodiments;

FIG. 4 is a block diagram of a system according to some embodiments; and

FIG. 5 is a block diagram of a system according to some embodiments.

### DETAILED DESCRIPTION

Some embodiments described herein are associated with a “network device”. As used herein, the term “network device” may generally refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem or a wireless phone. In some embodiments, network devices may comprise one or more network components, such as a Static Random Access Memory (SRAM) device or module, a network processor, and/or a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network devices. By way of example, a network may be configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

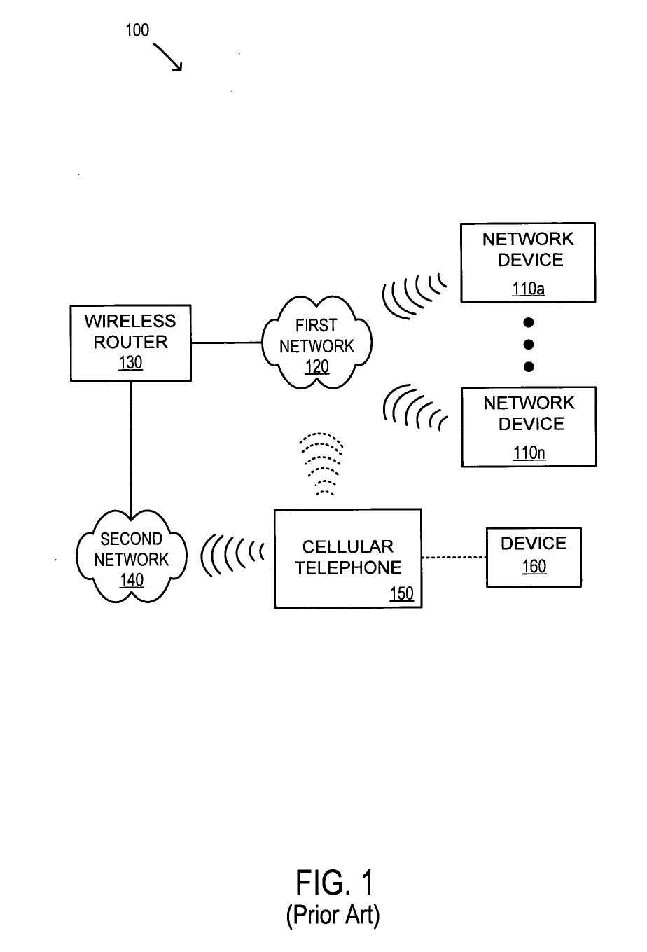

Referring first to FIG. 1, a block diagram of a communication system 100 is shown. The communication system 100 may, for example, be exemplary of a typical communication system utilized by a consumer. The communication system 100 may, in some configurations, include one or more network devices 110a-n coupled to a first network 120. The first network 120 may, for example, be a wireless LAN established and/or configured by, and/or otherwise associated with a wireless router 130. The wireless router 130 may, according to some configurations, provide the network devices 110a-n with access to the first network 120. The wireless router 130 may also be coupled to a second network 140. In some configurations, the network devices 110a-n may access the second network 140 via the wireless router 130 (and/or via the first network 120).

The first network 120 may, for example, be a wireless network within a consumer's home and/or office that is operated in accordance with “Information Technology-Telecommunications And Information Exchange Between Systems-Local And Metropolitan Area Networks” standard 802.11b-1999® published by the IEEE and/or the second network 140 may be an IP network such as an intranet, extranet, and/or the Internet. The network devices 110a-n may include, for example, various PC, home entertainment, security, and/or other network devices within and/or associated with the consumer's home and/or office. These network devices 110a-n may communicate with one another via the first network 120 (e.g., the wireless LAN) and/or may access the second network 140 (e.g., the Internet) via the wireless router 130.

The communication system 100 may also include the cellular telephone 150. The consumer may, for example, operate the cellular telephone 150 within the consumer's home and/or office and/or from one or more locations remote from the consumer's home and/or office. In some configurations, the cellular telephone 150 may operate as a standard cellular telephone by sending and/or receiving messages via a cellular network (not shown). The cellular telephone 150 may also be coupled to the second network 140. In the case that the second network 140 is the Internet, for example, the cellular telephone 150 may access the Internet using an internal modem. According to some configurations, the cellular telephone 150 may also be capable of communicating via the first network 120. When the cellular telephone 150 is operated within the consumer's home, for example, the cellular telephone 150 may be utilized to communicate via the first network 120.

In some configurations, a device 160 may be coupled to the cellular telephone 150. The device 160 may, for example, not be capable of communicating with and/or may not otherwise have access to the first network 120 and/or the second network 140 (e.g., a PC without wireless connectivity capabilities). In such a case, the cellular telephone 150 may be coupled to the device 160 to provide the device 160 with access to the first network 120 and/or the second network 140. The cellular telephone 150 may, in effect, be utilized as a modem to connect the device 160 to one or more of the networks 120, 140. The device 160 may be coupled to the cellular telephone 150 via any number of wired and/or wireless cables, links, and/or other connections. In one configuration, the cellular telephone 150 and the device 160 may be coupled via Bluetooth® technology to provide access to the second network 140 (e.g., the Internet) to the device 160.

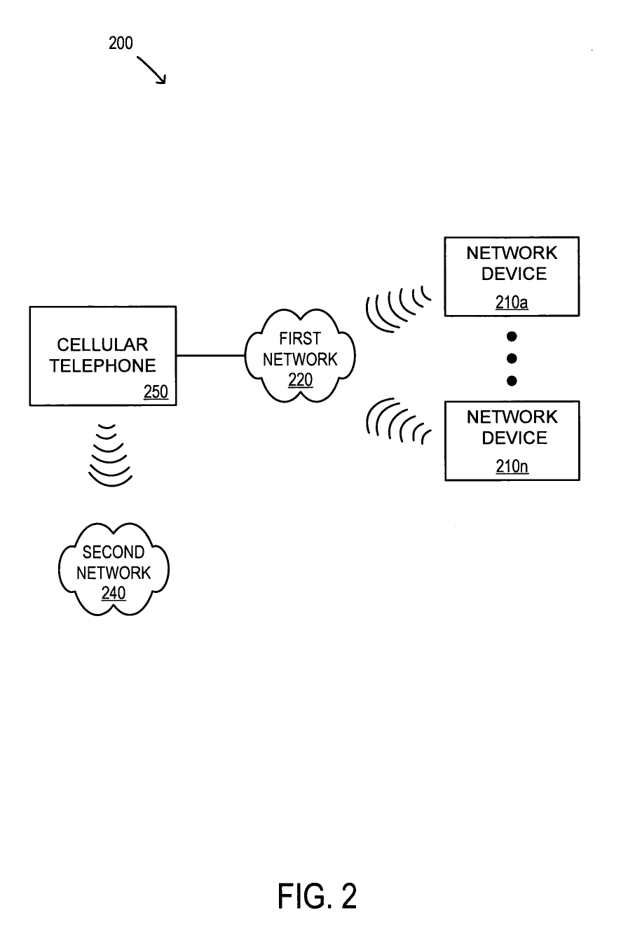

Turning to FIG. 2, a block diagram of a system 200 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 200 may comprise, for example, one or more network devices 210a-n. In some embodiments, the network devices 210a-n may be coupled to a first network 220. A second network 240 may also or alternatively be accessible to the network devices 210a-n via the cellular telephone 250 (e.g., functioning as a wireless router). In some embodiments, the cellular telephone 250 may provide the network devices 210a-n with access to the first network 220. According to some embodiments, the components 210a-n, 220, 240, 250 of the system 200 may be similar in configuration and/or functionality to the similarly-named components described in conjunction with FIG. 1.

The network devices 210a-n may, for example, be or include any type or configuration of network devices that are or become known. In some embodiments, the network devices 210a-n may include devices associated with a home and/or office networking environment. For example, the network devices 210a-n may include, but are not limited to, a PC, a PDA, a facsimile machine, a copier, a printer, a security system and/or sensor, an appliance, and/or a home entertainment system and/or component thereof. According to some embodiments, the network devices 210a-n may be configured to communicate in accordance with one or more protocols and/or standards.

In the case that the first network 220 operates in accordance with the 802.11b®, the Wireless LAN transmission standard 802.11b/g-1999/2003® published by the IEEE, and/or the Wireless Local Area Network (WLAN) standard 802.11h-2003® published by the IEEE, for example, the network devices 210a-n may be configured to communicate in accordance with the appropriate 802.11b/g/h® wireless protocol (e.g., Wireless Fidelity or “Wi-Fi” protocols). According to some embodiments, the cellular telephone 250 may also or alternatively be configured to communicate in accordance with an 802.11b/g/h® wireless protocol. Other protocols and/or wireless protocols (e.g., Bluetooth®) may also or alternatively be utilized by the network devices 210a-n, the first network 220, and/or the cellular telephone 250.

In some embodiments, the cellular telephone 250 may be associated with the creation, configuration, and/or management of the first network 220. The cellular telephone 250 may, for example, be utilized as a router, hub, and/or switch to manage network activity associated with the first network 220. According to some embodiments, the cellular telephone 250 may be utilized to edit, change, and/or configure a pre-existing first network 220 and/or may be utilized to define and/or establish the first network 220. The cellular telephone 250 may, for example, utilize one or more parameters and/or protocols to establish the first network 220 within a consumer's home and/or office environment. In other words, the cellular telephone 250 may establish an ad-hoc and/or wireless network that may be provided to the network devices 210a-n. In some embodiments, the cellular telephone 250 may transmit identification, configuration, and/or other signals associated with the first network 220. The network devices 210a-n may, for example, detect and/or receive the signals transmitted by the cellular telephone 250 to determine the existence and/or configuration of the first network 220.

According to some embodiments, any number of network devices 210a-n may be coupled to the first network 220 established and/or managed by the cellular telephone 250. The cellular telephone 250 may, for example, include the functionality of a switch, router, hub, network processor, and/or other network component to manage the connectivity of the network devices 210a-n. In some embodiments, the network devices 210a-n may be substantially simultaneously coupled to the first network 220 and/or the cellular telephone 250. The cellular telephone 250 may, for example, be capable of concurrently managing the flow of messages to and/or from any number of the network devices 210a-n.

In some embodiments, the cellular telephone 250 may also or alternatively be coupled to and/or in communication with the second network 240. The second network 240 may, for example, be a cellular telephone network that provides telephone services to the cellular telephone 250. Examples of the second network 240 may include, but are not limited to, a Global System for Mobile (GSM) communications network, a General Packet Radio Service (GPRS) network, an Enhanced GPRS (EGPRS) network, an Enhanced Data GSM Environment (EDGE) network, and/or a Universal Mobile Telecommunications System (UMTS) network. In some embodiments, the second network 240 may by operate in accordance with Code-Division Multiple Access (CDMA) and/or Time-Division Multiple Access (TDMA) standards. According to some embodiments, the second network may be or include an IP network such as the Internet. In some embodiments, the second network 240 may provide access to an IP network such as the Internet and/or may be or include any type or configuration of wireless network that is or becomes known.

In some embodiments, the cellular telephone 250 may act as a gateway between the first and second networks 220, 240. The cellular telephone 250 may, for example, act as a router to provide the network devices 210a-n with access to the second network 240. In the case that the network devices 210a-n are components of a consumer's home network (e.g., the first network 220), for example, the cellular telephone 250 may provide Internet (e.g., second network 240) access to the network devices 210a-n. In such a manner, for example, the consumer may need only purchase and/or operate the cellular telephone 250 to provide Internet access to a home and/or office network and/or to the network devices 210a-n thereof. In other words, the internal modem and/or other Internet access available to a cellular telephone 250 may be utilized (e.g., in place of a standard wireless router device) to provide Internet (and/or other network) access to a consumer's other network devices.

The cellular telephone 250 may, according to some embodiments, provide various services and/or perform various functions to facilitate the gateway services between the first and second networks 220, 240. The cellular telephone 250 may, for example, employ Dynamic Host Configuration Protocol (DHCP), Domain Name Service (DNS), and/or other network processing capabilities to facilitate the management of information within and/or between the networks 220, 240 and/or the network devices 210a-n. According to some embodiments, the cellular telephone 250 may provide load management, packet routing, identification, configuration, firewall, security, authentication, encryption, decryption, compression, decompression, and/or other networking services to the network devices 210a-n. The cellular telephone 250 may, for example, take the place of a typical wireless router.

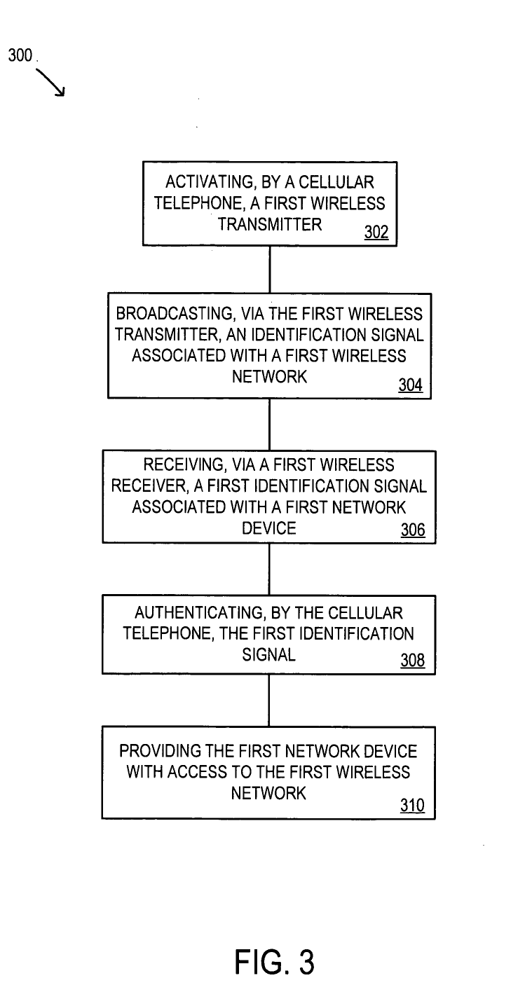

Referring now to FIG. 3, a method 300 according to some embodiments is shown. In some embodiments, the method 300 may be conducted by and/or by utilizing the system 200 and/or may be otherwise associated with the system 200 and/or any of the system components described in conjunction with FIG. 2. The method 300 may, for example, be performed by and/or otherwise associated with a cellular telephone 250 as described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by activating, by a cellular telephone, a first wireless transmitter. For example, a cellular telephone (such as the cellular telephone 250) may activate a first wireless transmitter such as a Wi-Fi transmitter. According to some embodiments, the first wireless transmitter may be activated upon the occurrence and/or determination of an event and/or condition. The first wireless transmitter may, for example, be activated upon powering on the cellular telephone and/or upon the receipt of an indication associated with activating the first wireless transmitter. A user of the cellular telephone may, according to some embodiments, select (e.g., from a menu) an option indicating that the first wireless transmitter is to be activated. In some embodiments, the first wireless transmitter may be activated upon coupling of the cellular telephone to a device and/or network and/or may be associated with the location of the cellular telephone. The first wireless transmitter may, for example, automatically be activated in the case that the cellular telephone enters a particular zone and/or area (like a home and/or office).

The method 300 may continue, according to some embodiments, by broadcasting, via the first wireless transmitter, an identification signal associated with a first wireless network, at 304. The cellular telephone may, for example, broadcast and/or otherwise transmit an identification signal representing a network associated with the cellular telephone. In some embodiments, the first wireless network may be a pre-existing network associated with the cellular telephone. The cellular telephone may, for example, come within proximity of and/or otherwise detect the first wireless network. According to some embodiments, the first wireless network may be established, created, configured, and/or otherwise manipulated and/or defined by the cellular telephone (e.g., and ad-hoc wireless network).

For example, the cellular telephone may establish a Wi-Fi network utilizing one or more parameters and/or protocols. At 304, the cellular telephone may broadcast an identification signal associated with the network so that other devices (e.g., network devices) may detect the presence of the network. The identification signal may include configuration and/or parameter information, for example, that facilitate the coupling of network devices to the first wireless network. In some embodiments, the first wireless network may be established, configured, and/or identified utilizing any standard and/or protocol that is or becomes known. According to some embodiments, the first wireless network may be or include a Wi-Fi network.

At 306, the method 300 may continue by receiving, via a first wireless receiver, a first identification signal associated with a first network device. The cellular telephone may, for example, include the first wireless receiver to receive information from devices capable of being coupled to the first wireless network. In some embodiments, the first identification signal may be received at least in part in response to the broadcasting at 304. The first network device may, for example, detect the broadcasted identification signal and transmit and/or otherwise provide the first network device's identification signal in order to gain access and/or facilitate coupling to the first wireless network. According to some embodiments, the first wireless receiver may be associated with the first wireless transmitter. The functionalities of both the first wireless transmitter and the first wireless receiver may, for example, be provided by a first wireless transceiver included within and/or otherwise associated with the cellular telephone.

According to some embodiments, the method 300 may continue at 308 by authenticating, by the cellular telephone, the first identification signal. The cellular telephone may, for example, compare the identification signal received at 306 to a list, table, database, and/or other lookup associated with registered and/or permitted devices. The wireless services offered and/or provided by the cellular telephone, according to some embodiments, may be intended for certain network devices and/or groups thereof. In the case that the cellular telephone is utilized in a home and/or office networking environment, for example, it may be desirable to only provide services to those devices recognized as being associated with the home and/or office network (e.g., such as when other wireless networks and/or other wireless devices operate in the vicinity of the home and/or office network). In some embodiments, the identification information received at 306 may include an identifier such as a Media Access Control (MAC) address and/or information indicative of such an address. The received MAC address may, for example, be verified as being associated with a pre-authorized device (e.g., established by a consumer, user, and/or administrator) by comparing the MAC address to a list of recognized and/or authorized MAC addresses.

In some embodiments, the method 300 may continue by providing the first network device with access to the first wireless network, at 310. The cellular telephone may, for example, function substantially as a wireless router to provide first wireless network access to the first network device. According to some embodiments, the cellular telephone may also or alternatively provide one or more network services in conjunction with providing access to the first wireless network. The cellular telephone may, for example, manage the flow of information to, from, and/or between various network devices (such as the first network device) and the first wireless network.

The method 300 may also or alternatively comprise various procedures related to one or more other networks such as a second network. The cellular telephone may, for example, also or alternatively provide the first network device (and/or other network devices) with access to a second network. In some embodiments, the cellular telephone may act as a gateway between the first and second networks. As an example, the cellular telephone may be utilized to establish an ad-hoc wireless network (e.g., the first network) that allows a plurality of network devices to connect, couple, and/or otherwise communicate (e.g., via the first wireless network).

The cellular telephone may also have access to a second network such as the Internet. According to some embodiments, the cellular telephone may provide second network (e.g., Internet) access to the plurality of network devices. In some embodiments, the cellular telephone may authenticate one or more of the network devices with the second network. At 308 (and/or utilizing a procedure similar to 308), for example, the cellular telephone may authenticate the first network device (and/or other network devices) with the first and/or second networks.

According to some embodiments, the second network may be or include a wireless network such as a cellular network. The cellular telephone may, for example, include an internal modem capable of accessing the Internet via a cellular network. In some embodiments, the cellular telephone may include a second transmitter, receiver, and/or transceiver to communicate via the second network. The first wireless transceiver (and/or transmitter and receiver) may, for example, be a Wi-Fi transceiver, and/or the second transceiver (and/or transmitter and receiver) may be a GSM and/or GPRS transceiver. In some embodiments, the second transceiver may also or alternatively be utilized by the cellular telephone to conduct typical cellular telephone functions (e.g., conduct voice calls, text messaging, and/or other communication functions). According to some embodiments, voice calls and/or other functions may be conducted concurrently with the providing of router services. In other words, a consumer may utilize the cellular telephone to conduct a voice conversation while the cellular telephone also operates as a wireless router.

The cellular telephone may, according to some embodiments, provide wireless router services and/or gateway services to multiple network devices. In some embodiments, the cellular telephone may conduct the method 300 and/or portions thereof, for example, to provide access to the second network to each of a plurality of network devices. In some embodiments, fewer or more procedures may be executed and/or performed in accordance with the method 300. The cellular telephone may not, for example, authenticate network devices attempting to connect to the first wireless network. In other words, the router services provided by the cellular telephone may be provided in an open and/or unrestricted manner. It may be desirable, for example, to allow any proximate network device to easily connect to the first wireless network and/or potentially unauthorized network devices may not be capable of connecting to the first wireless network (e.g., the first wireless network may be operated in a remote location). A user of the cellular telephone-may, for example, choose to forgo authentication procedures in order to increase router service performance (e.g., reduce network processing overhead).

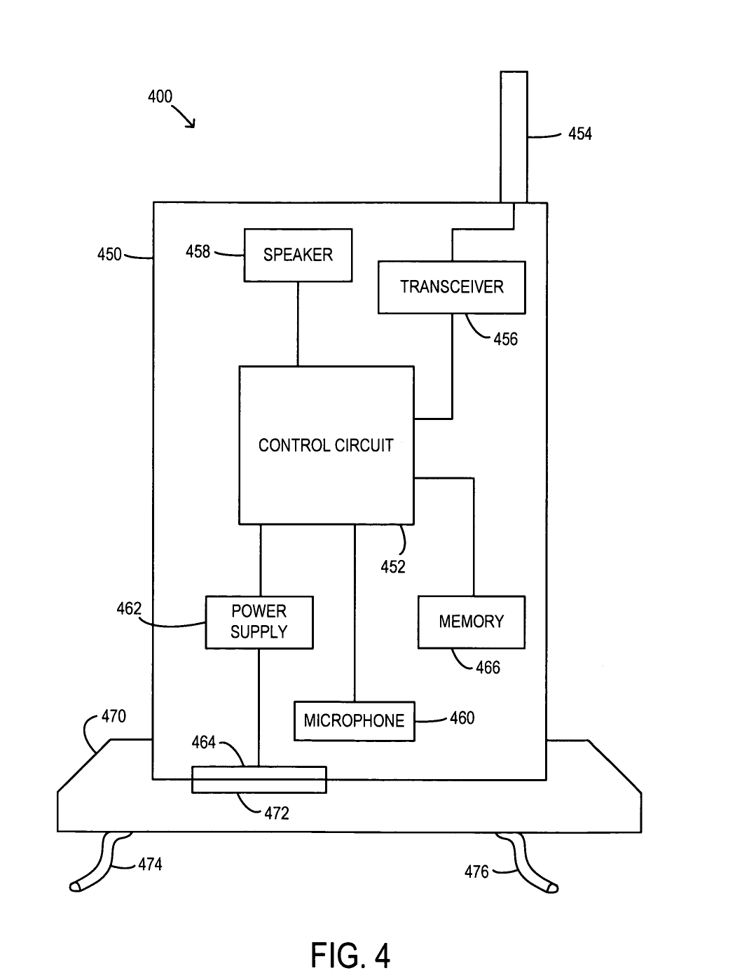

Turning now to FIG. 4, a block diagram of system 400 according to some embodiments is shown. The system 400 may, for example, be utilized to implement and/or perform the method 300 described herein and/or may be associated with the system 200 described in conjunction with FIG. 2. In some embodiments, fewer or more components than are shown in FIG. 4 may be included in the system 400. According to some embodiments, different types, layouts, quantities, and configurations of systems may be used.

In some embodiments, the system 400 may be or include a wireless communication device such as a wireless and/or cellular telephone 450. According to some embodiments, the cellular telephone 450 may be similar in functionality and/or configuration to the cellular telephone 250 described herein. The system 400 and/or the cellular telephone 450 may include, for example, one or more control circuits 452, which may be any type or configuration of processor, microprocessor, micro-engine, and/or any other type of control circuit that is or becomes known or available. In some embodiments, the system 400 may also or alternatively include an antenna 454, a transceiver 456, a speaker 458, a microphone 460, a power supply 462, a connector 464, and/or a memory 466, all and/or any of which may be in communication with the control circuit 452. The memory 464 may store, for example, code and/or other instructions operable to cause the control circuit 452 to perform in accordance with embodiments described herein.

The antenna 454 may be any type and/or configuration of device for transmitting and/or receiving communications signals that is or becomes known. The antenna 454 may protrude from the top of the cellular telephone 450 as shown in FIG. 4 or may also or alternatively be internally located, mounted on any other exterior portion of the system 400, or may be integrated into the structure or body of the cellular telephone 450 itself. The antenna 454 may, according to some embodiments, be configured to receive any number of communications signals that are or become known including, but not limited to, Radio Frequency (RF), Infrared Radiation (IR), satellite, cellular, optical, and/or microwave signals.

In some embodiments, the antenna 454 may be configured to send and/or receive signals in accordance with more than one protocol, configuration, and/or type. The antenna 454 may, for example, be configured to send and/or receive Wi-Fi and/or cellular network signals in accordance with embodiments described herein. According to some embodiments, the antenna 454 may send and/or receive signals to and/or from the transceiver 456. The transceiver 456 may, for example, be or include any type or configuration of electrical element capable of generating, receiving, managing, and/or otherwise processing signals sent and/or received to and/or from the antenna 454.

The transceiver 456 may, according to some embodiments, be a first transceiver as described herein. The transceiver 456 may, for example, be activated by the cellular telephone 450 (e.g., at 302), utilized to broadcast network identification information (e.g., at 304), utilized to receive network device identification information (e.g., at 306), and/or utilized, at least in part, to provide access to a second network (e.g., at 310). In some embodiments, the transceiver 456 may be or include multiple components.

For example, the transceiver 456 may be comprised of multiple transceivers. Each of the multiple transceivers may, in some embodiments, be configured to send and/or receive signals via different protocols, standards, and/or configurations. The transceiver 456 may, for example, be comprised of a first transceiver and a second transceiver. The first transceiver, according to some embodiments, may be configured to send and/or receive Wi-Fi signals, while the second transceiver may be configured to send and/or receive GSM, GPRS, and/or other wireless signals. According to some embodiments, the transceiver 456 may also or alternatively comprise separate transmitter and/or receiver components.

In some embodiments, the antenna 454 may also or alternatively comprise multiple components. In the case that the transceiver 456 is comprised of a first and a second transceiver, for example, the antenna 454 may be comprised of an antenna for each of the first and second transceivers. According to some embodiments, a single antenna 454 may be utilized in conjunction with multiple components of the transceiver 456.

The speaker 458 and/or the microphone 460 may be or include any types and/or configurations of devices that are capable of producing and capturing sounds, respectively. In some embodiments, the speaker 458 may be situated to be positioned near a user's ear during use of the cellular telephone 450, while the microphone 560 may, for example, be situated to be positioned near a user's mouth. According to some embodiments, fewer or more speakers 458 and/or microphones 460 may be included in the system 400.

The power supply 462 may, in some embodiments, be integrated into, removably attached to any portion of, and/or be external to the system 400 and/or the cellular telephone 450. The power supply 462 may, for example, include one or more battery devices that are removably attached to the back of the cellular telephone 450. The power supply 462 may, according to some embodiments, provide Alternating Current (AC) and/or Direct Current (DC), and may be any type or configuration of device capable of delivering power to the system 400 and/or the cellular telephone 450 that is or becomes known or practicable. In some embodiments, the power supply 462 may interface with the connector 464. The connector 464 may, for example, allow the cellular telephone 450 to be interfaced with and/or connected to external components such as external speakers, microphones, and/or battery charging devices. According to some embodiments, the connector 464 may allow the cellular telephone 450 to be coupled to receive power from external sources and/or may provide recharging power to the power supply 462.

In some embodiments, the memory 466 may store any number and/or configuration of programs, modules, procedures, and/or other instructions that may, for example, be executed by the control circuit 452. The memory 466 may, for example, include logic that allows the control circuit 452 to provide router and/or other network component functionality to the cellular telephone 450. In some embodiments, the memory 466 may also or alternatively include logic that allows the cellular telephone 450 to operate as a gateway between two or more networks. According to some embodiments, the memory 466 may store a database, tables, lists, and/or other data that allow the control circuit 452 to authorize and/or validate one or more network devices in communication with the cellular telephone 450. The memory 466 may, for example, store a list of pre-authorized, recognized, and/or otherwise identifiable network devices (and/or identifiers associated therewith) that may be compared to signals received from various network devices to determine if those devices should be granted access to a network and/or provided with wireless routing and/or network services. In some embodiments, the memory 466 may store other instructions such as operation and/or command execution rules, security features (e.g., passwords), and/or user profiles.

According to some embodiments, the system 400 may also or alternatively comprise a docking device 470. The docking device 470 may, for example, comprise a connector 472, a power supply path 474, and/or a signal path 476. In some embodiments, the docking device 470 may be configured to be coupled to the cellular telephone 450. The docking device 470 may, for example, physically and/or electrically couple to the cellular telephone 450. In some embodiments, the connector 472 of the docking device 470 may mate with the connector 464 of the cellular telephone 450. The mating of the connectors 464, 472 may, for example, provide an interface between the cellular telephone 450 and the docking device 470.

In some embodiments, the docking device 470 may provide the cellular telephone 450 with power. The docking device 470 may utilize the power supply path 474, according to some embodiments, to receive power (e.g., from a battery, AC power outlet, and/or other source) and provide the power via the connector 472 to the cellular telephone 450 (e.g., via the connector 464). The power supply 462 may, for example, be charged, re-charged, and/or bypassed to provide power to the cellular telephone 450. In the case that the cellular telephone 450 is utilized to provide wireless routing services to a plurality of network devices, for example, it may be desirable to couple the cellular telephone 450 to the docking device 470 to prevent and/or reduce the drain of power from the power supply 462. A consumer utilizing the cellular telephone 450 to provide wireless home networking services, for example, may place the cellular telephone 450 into the docking device 470 to maintain the charge of the power supply 462 by providing the cellular telephone with power (e.g., via the power supply path 474) from an outlet in the consumer's home.

The docking device 470 may also or alternatively provide enhanced signal transmission and/or reception capabilities to the cellular telephone 450. The docking device 470 may, for example, be connected to an external antenna (not shown) and/or other device (e.g., a signal amplifier) via the signal path 476. The cellular telephone 450 may utilize the signal path 476 via the connectors 464, 472, according to some embodiments, to extend the range over which the cellular telephone 450 may send and/or receive signals. The signal path 476 may, for example, enhance the range, size, and/or quality of a Wi-Fi network established, configured, and/or managed by the cellular telephone 450 (e.g., within a consumer's home and/or office).

According to some embodiments, the coupling of the docking device 470 to the cellular telephone 450 may trigger one or more events and/or satisfy one or more conditions. For example, the control circuit 452 may detect the coupling to the docking device 470 and/or may determine that one or more actions should be taken. The control circuit 452 may, in some embodiments, execute one or more processes stored within the memory 466 that monitor the cellular telephone 450 for various triggers and/or events. In the case that the cellular telephone 450 is coupled to the docking device 470, for example, the processes may detect the coupling and/or determine that one or more other procedures and/or actions should be executed.

For example, instruction stored in the memory 466 may provide that in the case the cellular telephone is coupled to the docking device 470, the power supply 462 should be bypassed and/or re-charged to conserve energy within the power supply 462 and/or to take advantage of the power being supplied via the power supply path 474. The instructions may also or alternatively provide that the transceiver is to be activated upon coupling to the docking device 470 and/or upon receiving power via the connector 464 (e.g., from an external source). In the case that the transceiver 456 comprises a first and a second transceiver, for example, the coupling to the docking device 470 may activate the first transceiver (e.g., at 302).

As an example, a consumer may utilize the cellular telephone 450 as a typical cellular telephone within the consumer's home (and/or elsewhere). The consumer may then, for example, place the cellular telephone in the docking device 470 (such as a dedicated routing cradle) to initiate wireless routing services via the cellular telephone 450. The docking device 470 may also or alternatively comprise other paths, ports, connections, and/or other features not shown in FIG. 4. The docking device 470 may, for example, be or include a network hub and/or switch allowing wired devices to connect to and/or interface with the cellular telephone 450.

In some embodiments, the wireless routing services may be provided regardless of connection with a docking device 470. The cellular telephone 450 may provide routing services and/or otherwise be utilized, according to some embodiments, without being coupled to and/or associated with the docking device 470. The consumer may configure the cellular telephone 450, for example, to choose when and/or how the wireless routing services should be provided and/or to define one or more triggers and/or events associated with router services. In some embodiments, the consumer may utilize the cellular telephone 450 to configure a wireless network (such as a wireless LAN) associated with providing routing services to various network devices. In some embodiments, the cellular telephone 450 may be configured to automatically establish a wireless network and/or to automatically provide router services upon the occurrence of certain events (e.g., like in the case when the cellular telephone 450 is carried into a home and/or office).

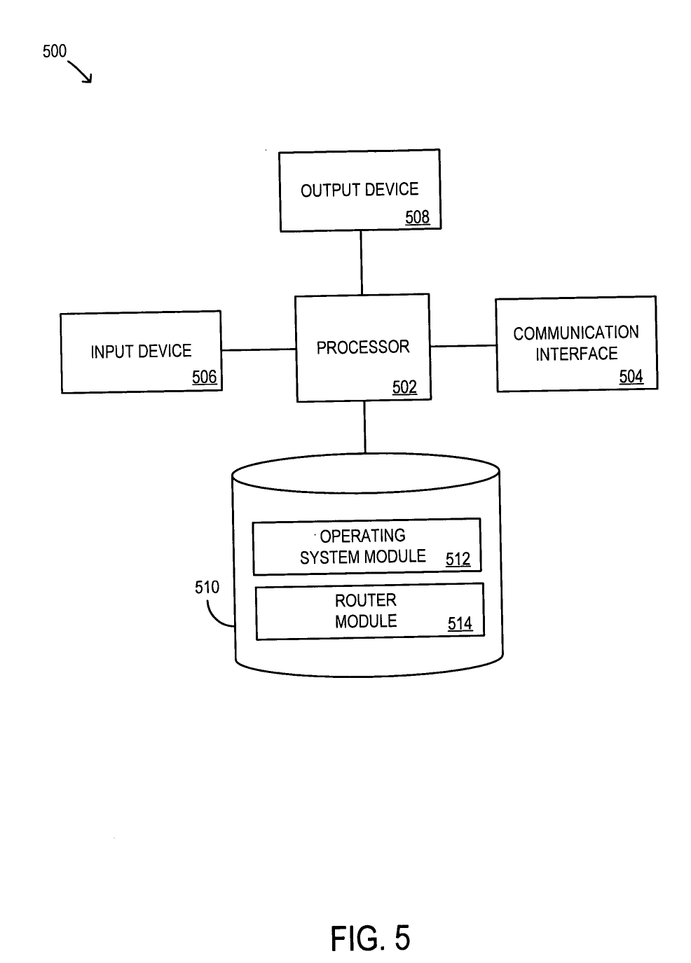

Turning now to FIG. 5, a block diagram of a system 500 according to some embodiments is shown. The system 500 may, for example, be utilized to implement and/or perform the method 300 described herein and/or may be associated with the systems 200, 400 described in conjunction with any of FIG. 2, and/or FIG. 4. In some embodiments, fewer or more components than are shown in FIG. 5 may be included in the system 500. According to some embodiments, different types, layouts, quantities, and configurations of systems may be used.

In some embodiments, the system 500 may be or include a communication device such as a wireless and/or cellular telephone. According to some embodiments, the system 500 may be a cellular telephone such as the cellular telephones 250, 450 described herein. In some embodiments, the system 500 may include one or more processors 502, which may be any type or configuration of processor, microprocessor, and/or micro-engine that is or becomes known or available. In some embodiments, the system 500 may also or alternatively include a communication interface 504, an input device 506, an output device 508, and/or a memory device 510, all and/or any of which may be in communication with the processor 502. The memory device 510 may store, for example, an operating system module 512 and/or a router module 514.

The communication interface 504, the input device 506, and/or the output device 508 may be or include any types and/or configurations of devices that are or become known or available. According to some embodiments, the input device 506 may include a keypad, one or more buttons, and/or one or more softkeys and/or variable function input devices. The input device 506 may include, for example, any input component of a wireless and/or cellular telephone, such as a touch screen and/or a directional pad or buttons.

The memory device 510 may be or include, according to some embodiments, one or more magnetic storage devices, such as hard disks, one or more optical storage devices, and/or solid state storage. The memory device 510 may store, for example, the operating system module 512 and/or the router module 514. The modules 512, 514 may be any type of applications, modules, programs, and/or devices that are capable of facilitating network routing, processing, and/or management. Either or both of the operating system module 512 and/or the router module 514 may, for example, include instructions that cause the processor 502 to operate the system 500 in accordance with embodiments as described herein.

For example, the operating system module 512 may cause the system 500 to monitor for the occurrence of events, may provide instructions for interfacing with a user via the input device 506 and/or the output device 508, and/or may manage and/or conduct cellular telephone sessions via the communication interface 504. The operating system module 512 may also or alternatively provide various applications and/or programs that may be utilized to provide cellular telephone functionality to the system 500.

The router module 514 may, according to some embodiments, be or include a module that allows and/or facilitates the system 500 to provide wireless router services. In some embodiments, the system 500 may, for example, comprise a typical cellular telephone modified by the addition of the router module 514 (and/or other modules and/or devices such as a secondary transceiver, etc.). The router module 514 may, for example, allow the cellular telephone to establish a wireless network (such as an ad-hoc and/or on-the-fly Wi-Fi network) and/or to provide gateway and/or routing services to a plurality of network devices. In some embodiments, the router module 514 may include instructions similar to those associated with a network processor. The router module 514 may, for example, include code that allows the system 500 to provide DNS and/or DHCP services, load management, firewall, and/or other networking services.

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A cellular telephone, comprising:
a first wireless transceiver to communicate via a first wireless network;
a memory configured to store instructions;
a processor coupled to the memory and the first transceiver, the processor being configured to execute the stored instructions to provide a plurality of network devices with access to the first wireless network.

2. The cellular telephone of claim 1, wherein the processor is further configured to execute the stored instructions to provide the plurality of network devices with access to a second network.

3. The cellular telephone of claim 2, wherein the providing the plurality of network devices with access to the second network comprises operating as a gateway between the first wireless network and the second network.

4. The cellular telephone of claim 2, further comprising:
a second wireless transceiver to communicate via the second network.

5. The cellular telephone of claim 4, wherein the second wireless transceiver comprises one or more of a General Packet Radio Service (GPRS), an Enhanced GPRS (EGPRS), a Global System for Moblie communications (GSM), an Enhanced Data GSM Environment (EDGE), a Universal Mobile Telecommunications System (UMTS), a Code-Division Multiple Access (CDMA), or a Time-Division Multiple Access (TDMA) transceiver.

6. The cellular telephone of claim 1, wherein the first wireless transceiver comprises a Wireless Fidelity (Wi-Fi) transmitter.

7. The cellular telephone of claim 1, wherein the processor is further configured to execute the stored instructions to provide at least one of a Dynamic Host Configuration Protocol (DHCP) or a Domain Name Service (DNS) to the plurality of network devices.

8. The cellular telephone of claim 1, further comprising:
an interface to communicate with a docking device, wherein the docking device is to provide one or more of power or an extended-range antennae.

9. A method, comprising:
activating, by a cellular telephone, a first wireless transmitter;
broadcasting, via the first wireless transmitter, an identification signal associated with a first wireless network;
receiving, via a first wireless receiver, a first identification signal associated with a first network device;
authenticating, by the cellular telephone, the first identification signal; and
providing the first network device with access to the first wireless network.

10. The method of claim 9, further comprising:
providing the first network device with access to a second network.

11. The method of claim 10, wherein access to the second network is provided by utilizing a second wireless transmitter and a second wireless receiver.

12. The method of claim 10, wherein the providing access to the second network comprises:
managing an exchange of signals between the second network and the first network device.

13. The method of claim 9, further comprising:
receiving, via the first wireless receiver, a second identification signal associated with a second network device;
authenticating, by the cellular telephone, the second identification signal; and
providing the second network device with access to the first wireless network.

14. The method of claim 13, wherein the access to the first wireless network is provided substantially simultaneously to both the first and second network devices.

15. The method of claim 9, further comprising:
defining, by the cellular telephone, the first wireless network.

16. The method of claim 9, further comprising:
determining the occurrence of an event.

17. The method of claim 16, wherein the activating of the first wireless transmitter is based at least in part on the occurrence of the event.

18. The method of claim 16, wherein the event includes at least one of the receipt of input from a user or the coupling of the cellular telephone to a docking device.

19. The method of claim 9, further comprising:
coupling the cellular telephone to a docking device;
receiving, via the docking device, a second identification signal associated with a second network device;
authenticating, by the cellular telephone, the second identification signal; and
providing the second network device with access to the first wireless network.

20. The method of claim 19, wherein the docking device provides power to the cellular telephone.

21. The method of claim 19, wherein the second identification signal is received via an antenna associated with the docking device.
